(19) United States
(12) Patent Application Publication
(10) Pub. No.: US 2006/0026584 A1
(43) Pub. Date: Feb. 2, 2006

(54) Explicit linking of dynamic link libraries

(76) Inventors: Richard D. Muratori, Stow, MA (US); Dwight P. Manley, Holliston, MA (US)

Correspondence Address: FISH & RICHARDSON, PC, P.O. BOX 1022, MINNEAPOLIS, MN, 55440-1022, US

(21) Appl. No.: 10/900,588

(22) Filed: Jul. 27, 2004

(51) Int. Cl. G06F 9/44

(52) U.S. Cl. 717/163

(57) ABSTRACT

Dynamic link libraries (DLL) are loaded and linked so that exported symbols of each DLL can be accessed by the other DLLs. A method includes explicitly loading a first DLL and instructing the first DLL to explicitly load a second DLL to cause exported symbols of the second DLL to be accessible to the first DLL. The second DLL has code to implement an initialization routine to load another DLL. The first DLL calls the initialization routine in the second DLL to load the first DLL to cause exported symbols of the first DLL to be accessible to the second DLL.

### BACKGROUND

A dynamic link library (DLL) is a pre-compiled and executable collection of functions or routines that can be loaded by an application program during execution of the program. A DLL provides a list of names of sharable symbols (e.g., functions, routines, variables) that can be exported and used by other application programs or DLLs. The application program and its DLLs can implicitly or explicitly import (access) sharable symbols of other DLLs.

Implicit access is generally achieved by statically linking to the DLLs. The names of symbols imported by applications or DLLs are listed in header files used during compilation of the applications and DLLs. Statically linked DLLs are loaded into memory upon initiation of the application program so that the sharable functions of the DLLs become available. The addresses of the sharable functions required by the application program for accessing the functions are fixed at initiation and do not change during execution of the application program. The loaded DLLs generally are removed from the memory when the application program ends.

### DESCRIPTION OF DRAWINGS

FIG. 1 shows a block diagram of a computer system including a simulation system for simulating processors.

FIG. 2 shows a block diagram of the simulation system.

FIG. 3 shows a flow diagram of a process for loading multiple DLLs and linking the loaded DLLs in order to simulate the processor.

FIG. 4 shows a flow diagram of an initialization routine that is executed when loading a DLL.

FIG. 5 shows a flow diagram of a DLL exit routine that is used to unload one or more DLLs.

FIG. 6 shows a flow diagram of a routine for obtaining an address of an exported function of a DLL.

FIG. 7 shows a flow diagram of a process for executing an exported function of a DLL.

FIG. 8 shows a flow diagram of a process for automatically generating code that implements the process show in FIG. 7.

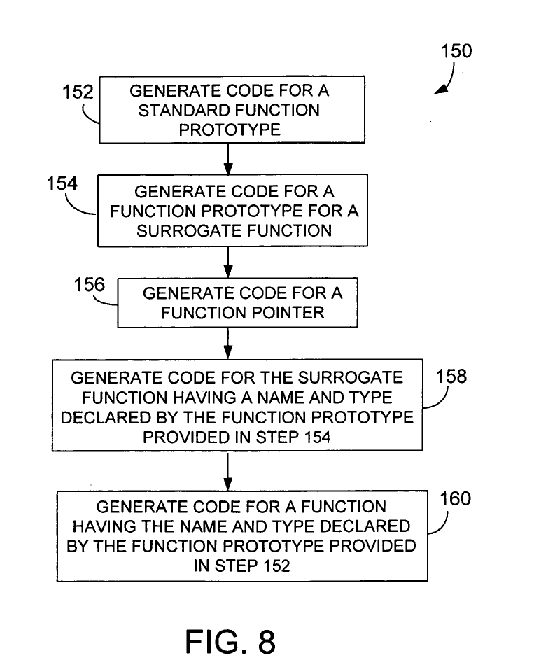

FIG. 9 shows a block diagram of a simulation system.

### DETAILED DESCRIPTION

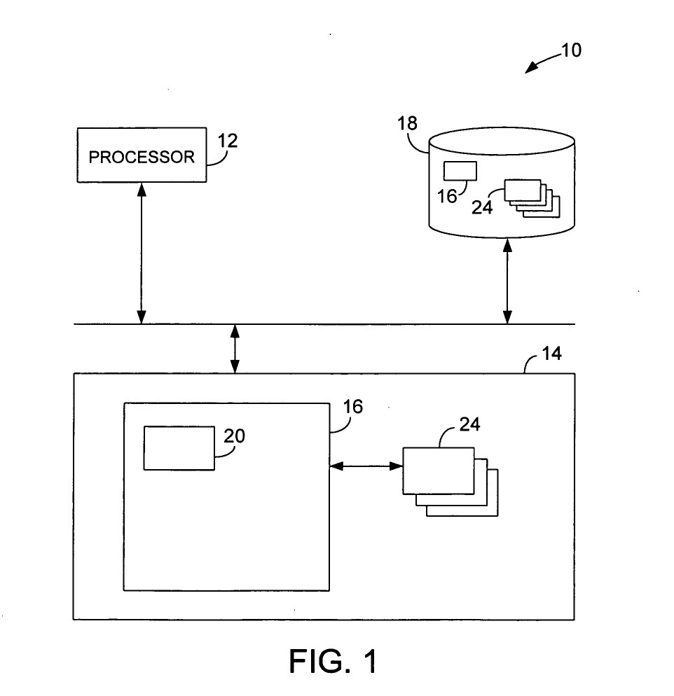

FIG. 1 shows a computing system 10 including a processor 12 and memory 14 that execute a simulation application program 16 stored in storage 18. Storage 18 can be, for example, a magnetic hard drive or an optical disc drive. The simulation application program 16 simulates the execution of a processor. The simulation application program 16 executed in memory 14 includes a loader process 20 that loads DLL's 24 used by the simulation application program 16. Not shown, but which are generally included are user and device interfaces and so forth.

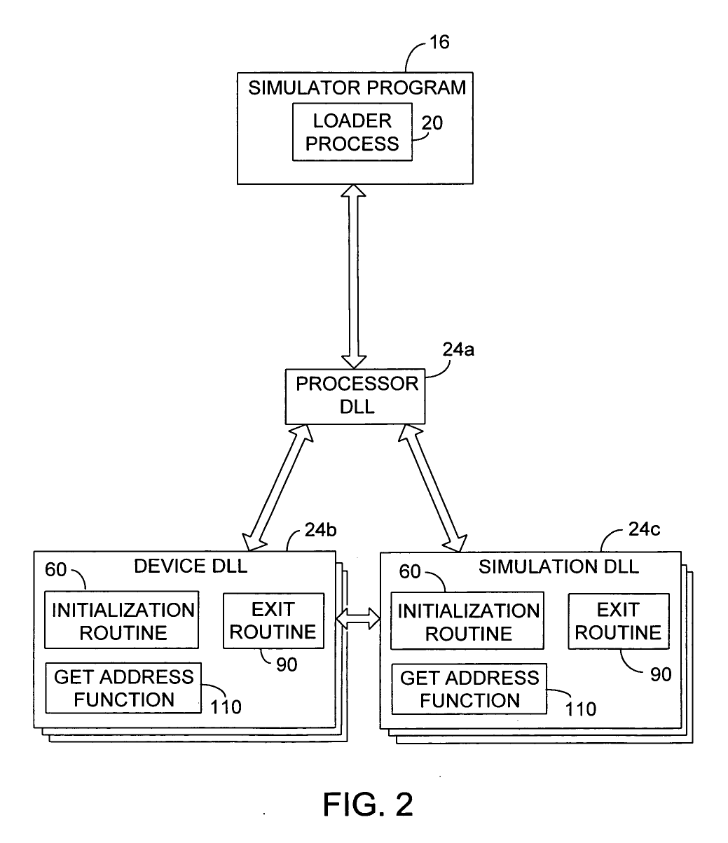

FIG. 2 shows the simulator program 16 explicitly loading a processor DLL 24a, device DLLs 24b, and simulator DLLs 24c so that the simulator program 16 can access sharable functions of each of the DLLs. Each time a new DLL is loaded, the new DLL is linked with previously loaded DLLs so that exported functions of the new DLL are accessible to the previously loaded DLLs, and that the exported functions of previously loaded DLLs are accessible to the new DLL.

In one example, the simulator program 16 is configured to simulate and test different processor models. A corresponding processor DLL 24a includes parameters of a particular processor model. The processor can be, e.g., a central processing unit, a microcontroller, a network processor, or another processor type. Each processor DLL 24a exports a number of sharable functions. Examples of the exported functions of the processor DLL 24a include functions for accessing and updating processor simulated states, functions for printing messages on a console associated with the processor DLL 24a, and functions for validating the application programming interface versions.

Each processor DLL 24a is associated with a corresponding set of device DLLs 24b and a set of simulation DLLs 24c. Each device DLL 24b includes parameters of device models that represent devices on a circuit board on which the processor is mounted. Examples of the devices include memory devices, bus interfaces, clock devices, other logic circuits and interconnects. The processor DLL 24a models the operations of a processor, which depend on conditions of the external devices (i.e., devices external to the processor). Each simulation DLL 24c includes, e.g., control functions for managing resources and controlling the simulation process, initialization of the device models, in conjunction with the processor DLL 24a and the device DLL 24b. The processor DLL 24a, the device DLLs 24b, and the simulation DLLs 24c communicate with one another to update internal states based on information provided by the other DLLs.

Each of the device DLLs 24b and the simulation DLLs 24c includes code for an initialization routine 60, an exit routine 90, and a proxy get address function 110, to be described later.

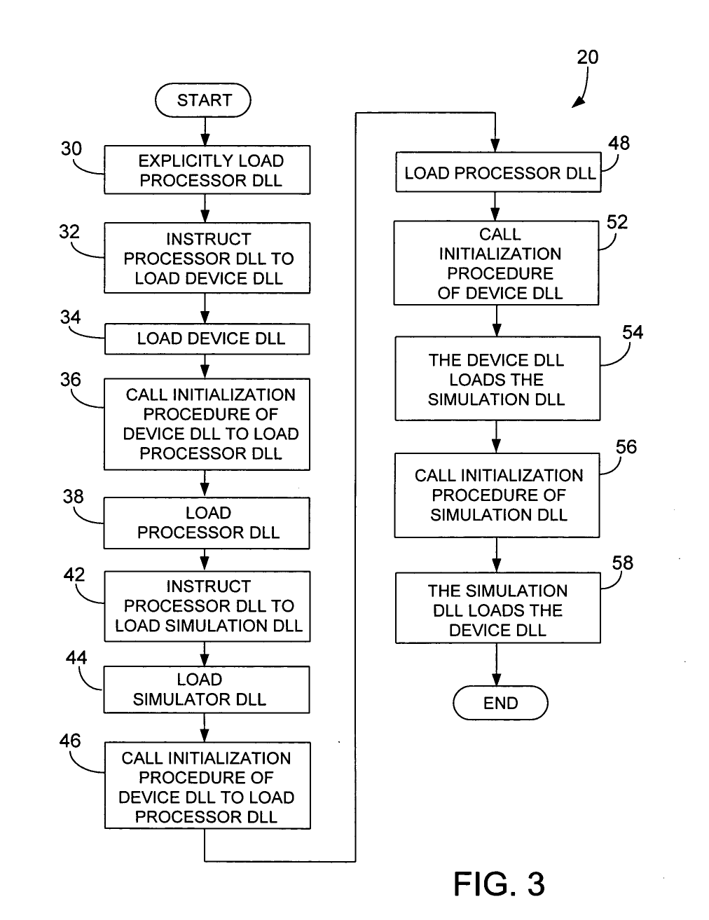

FIG. 3 shows the loader process 20 for loading the DLLs and linking each DLL to the other DLLs. To simulate and test a particular processor model, the simulator program 16 explicitly loads 30 a specific processor DLL 24a. In one example, the simulator program 16 calls a load library function (e.g., LoadLibrary, which is a standard Microsoft Windows function) to load the DLL. The first request to load the processor DLL 24a causes the processor DLL 24a to be loaded from the storage 18 to the memory 14. An address of the processor DLL 24a and a data structure describing the processor DLL 24a are returned to the simulator program 16.

The simulator program 16 instructs 32 the processor DLL 24a to run an initialization script to load and link to the other DLLs. The initialization script includes an instruction that requests the processor DLL 24a to explicitly load a device DLL 24b. The processor DLL 24a loads 34 the device DLL 24b so that exported functions of the device DLL 24b are accessible to the processor DLL 24a. An address of the device DLL 24b and a data structure describing the device DLL 24b are returned to the processor DLL 24a. A structure including the name of the device DLL 24b and a handle pointing to the device DLL 24b is added to a loaded DLL list maintained by the processor DLL 24a.

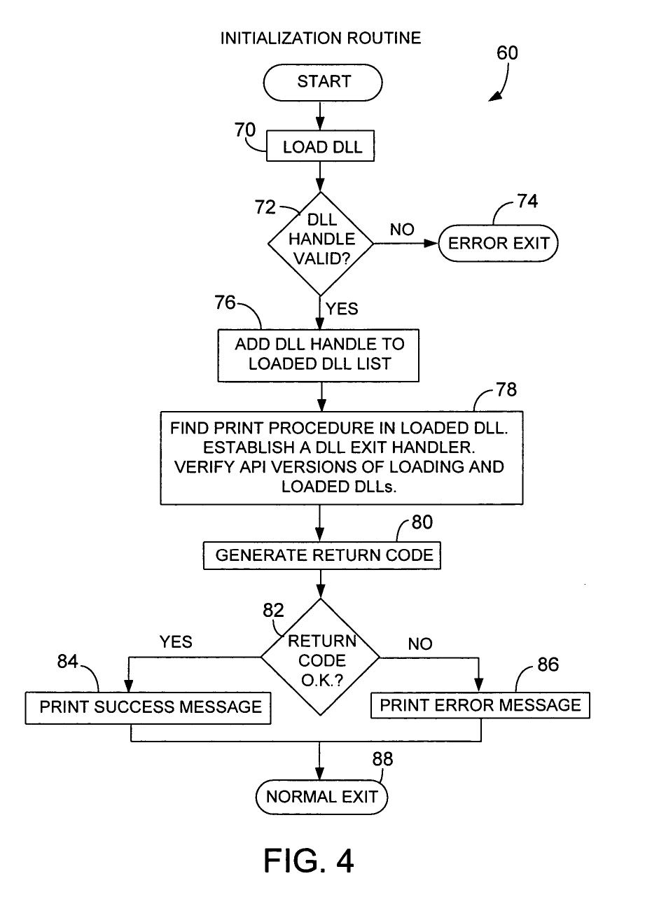

The processor DLL 24a calls 36 the initialization routine 60 of the device DLL 24b to dynamically link the processor DLL 24a to the device DLL 24b. The initialization routine 60 is inserted in the device DLL 24b when the device DLL 24b was initially generated. Each DLL that is to be loaded by the processor DLL 24a includes an initialization routine that is similar to the initialization routine 60, which is shown in FIG. 4.

The processor DLL 24a call 36 to the initialization routine 60 is used to request the initialization routine 60 to load 38 the already loaded processor DLL 24a. A handle referencing the already loaded processor DLL 24a is returned to the device DLL 24b so that the device DLL 24b can access the exported functions of the processor DLL 24a. A structure including the name of the processor DLL 24a and the handle referencing the processor DLL 24a is added to a loaded DLL list maintained by the device DLL 24b. The initialization routine 60 (discussed in FIG. 3) when executed allows the device DLL 24b to have transparent access to shared resources of the processor DLL 24a.

The simulator program 16 instructs 42 the processor DLL 24a to explicitly load a simulation DLL 24c. The processor DLL 24a explicitly loads 44 the simulation DLL 24c so that exported functions of the simulation DLL 24c are accessible to the processor DLL 24a. An address of the simulation DLL 24c and a data structure describing the simulation DLL 24c are returned to the processor DLL 24a. A structure that includes the name of the simulation DLL 24c and the handle referencing the simulation DLL 24c is placed on the loaded DLL list maintained by the processor DLL 24a.

The processor DLL 24a calls 46 the initialization routine 60 of the simulation DLL 24c to dynamically link the processor DLL 24a to the simulation DLL 24c. The initialization routine 60 is inserted into the simulation DLL 24c when the simulation DLL 24c is generated. The processor DLL 24a instructs the initialization routine 60 to load 48 the already loaded processor DLL 24a. A handle referencing the already loaded processor DLL 24a is returned to the simulation DLL 24c so that the simulation DLL 24c can access the exported functions of the processor DLL 24a. A structure that includes the name of the loaded processor DLL 24a and the handle referencing the processor DLL 24a is added to a loaded DLL list that is maintained by the simulation DLL 24c. The initialization routine 60 when executed allows the simulation DLL 24c to have transparent access to shared resources of the processor DLL 24a.

After linking the processor DLL 24a to the simulation DLL 24c, the processor DLL 24a calls 52 the initialization routine 60 of the device DLL 24b and passes the name of the simulation DLL 24c to the device DLL 24b. The device DLL 24b loads 54 the simulation DLL 24c to make the exported functions of the simulation DLL 24c accessible to the device DLL 24b. A structure that includes the name of the simulation DLL 24c and a handle referencing the simulation DLL 24c is added to the loaded DLL list maintained by the device DLL 24b.

The processor DLL 24a calls 56 the initialization routine 60 of the simulation DLL 24c and passes the name of the device DLL 24b to the simulation DLL 24c. The simulation DLL 24c loads 58 the device DLL 24b to make the exported functions of the device DLL 24b accessible to the simulation DLL 24c. A structure that includes the name of the device DLL 24b and a handle referencing the device DLL 24b is added to the loaded DLL list maintained by the simulation DLL 24c.

In this way, the exported functions of each of the processor DLL 24a, the device DLLs 24b, and the simulation DLLs 24c are accessible to the other DLLs. Each of the DLLs 24a, 24b, and 24c can access the exported functions of the other DLLs. Each DLL maintains a list of the names of the other DLLs and handles pointing to the other DLLs.

In process 20, the steps 34, 36, and 38 are similar to steps 44, 46, and 48, respectively. The step 52 is similar to the step 36, except that in step 36, the name and file path of the processor DLL 24a is passed to the initialization routine 60 of the device DLL 24b, whereas in step 52, the name and file path of the simulation DLL 24c is passed to the initialization routine 60 of the device DLL 24b. The step 56 is similar to the step 52, except that in step 52, the name and file path of the simulation DLL 24c is passed to the initialization routine 60 of the device DLL 24b, whereas in step 56, the name and file path of the device DLL 24b is passed to the initialization routine 60 of the simulation DLL 24c.

The processor DLL 24a may load more than one device DLL 24b and more than one simulation DLL 24c. To load a new DLL so that the exported functions of the new DLL can be accessed by previously loaded DLLs, and that the exported functions of the previously loaded DLLs can be accessed by the new DLL, steps similar to those described above are repeated.

The simulator program 16 instructs the processor DLL 24a to explicitly load the new DLL so that exported functions of the new DLL is accessible to the processor DLL 24a. The processor DLL 24a calls an initialization routine 60 of the new DLL to dynamically link the processor DLL 24a to the new DLL. The initialization routine 60 is inserted into the new DLL when the new DLL was generated. The processor DLL 24a call to the initialization routine 60 of the new DLL is used to request the initialization routine 60 to load the processor DLL 24a so that the exported functions of the processor DLL 24a become accessible to the new DLL.

The processor DLL 24a calls the initialization routine 60 of each previously loaded DLLs to explicitly load the new DLL, and make the exported functions of the new DLL accessible to each of the previously loaded DLLs. The processor DLL 24a calls the initialization routine 60 of the new DLL to explicitly load each of the previously loaded DLLs, and make the exported functions of the previously loaded DLLs accessible to the new DLL. In this way, regardless of how many DLLs are loaded, the exported functions of each DLL are accessible by the other DLLs.

FIG. 4 shows a flow diagram of the initialization routine 60. The initialization routine 60 loads 70 the DLL whose name was passed to the initialization routine when the initialization routine was called. When a DLL is loaded, a handle referencing the loaded DLL is returned to the initialization routine 60.

For example, in step 36 of FIG. 3, the processor DLL 24a calls the initialization routine 60 of the device DLL 24b and passes the name of the processor DLL 24a, so that the initialization routine 60 loads the processor DLL 24a, receiving a handle referencing the processor DLL 24a. As another example, in step 56 of FIG. 3, the processor DLL 24a calls the initialization routine 60 of the simulation DLL 24c and passes the name of the device DLL 24b, so that the initialization routine 60 loads the device DLL 24b, receiving a handle referencing the device DLL 24b.

The returned DLL handle is examined 72 to determine whether it is valid. If the handle is not valid (e.g., it is null), the routine 60 exits 74. If the handle is valid, a structure including the name of the DLL and the handle is added 76 to a loaded DLL list. The loaded DLL list includes the names and handles associated with the DLLs that have been loaded by the DLL in which the initialization routine 60 resides, which in this case is the device DLL 24b.

The initialization routine 60 finds 78 a print function in the loaded DLL to print success or error messages. In one example, the simulator program 16 opens a console (or window) to display text and data. When the initialization routine 60 loads the processor DLL 24a (in step 36), and an error occurs, the error is displayed in the console opened by the simulator program 16.

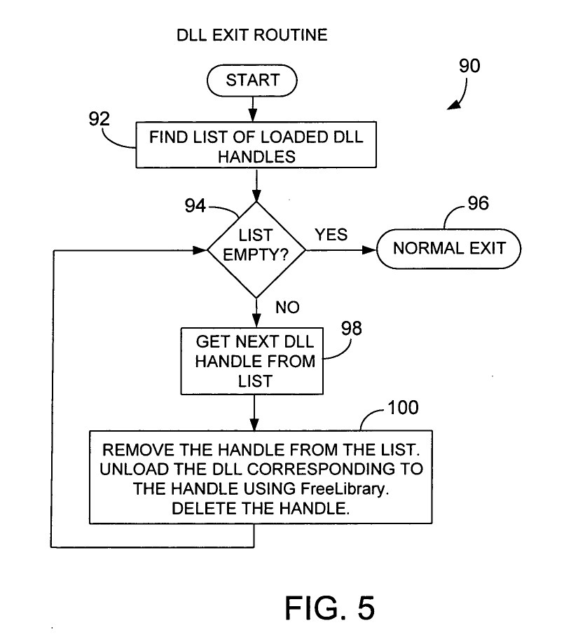

The initialization routine 60 establishes 78 a DLL exit handler (see FIG. 5) to allow the DLL, and other DLLs loaded by the DLL, to be properly removed. The initialization routine 60 verifies 78 the application programming interface (API) versions of the loading DLL (in this example, the device DLL 24b) and the loaded DLL (in this example, the processor DLL 24a). Verification ensures consistency of the type and number of arguments that are passed from the loading DLL to the loaded DLL.

The initialization routine 60 generates 80 a return code, in which specific bits are set (or cleared) if there are errors. For example, bit 1 may indicate that there is an error in finding a print function in the loaded DLL, bit 2 may indicate that there is an error in establishing a DLL exit handler, and bit 3 may indicate that there is an error in verifying the API versions. The return code is evaluated 82 to determine whether it indicates errors. If the return code does not indicate errors, a success message is printed 84, and the routine 60 exits 88. If the return code indicates errors, an error message is printed 86, and the routine 60 exits 88.

The print function in the loaded DLL is listed in a header file of the loaded DLL that lists the exported functions. In one example, if the print function can be found, a DLL exit handler can be established, and the API versions of the loading and loaded DLLs verified, it is assumed that the other exported functions can also be properly accessed.

FIG. 5 shows a flow diagram of the DLL exit routine 90, which is used for removing a DLL (and the other DLLs loaded by the DLL) from system memory 14 (FIG. 1). The exit routine 90 finds 92 the list of loaded DLLs (which includes the handles of the DLLs that are loaded by the DLL to be removed). The exit routine 90 tests 94 to determine whether the list is empty. If the list is empty, the routine 90 exits 96. If the list is not empty, the next DLL handle is obtained 98 from the list. The handle is removed 100 from the list. A free library function (e.g., FreeLibrary, which is a standard Microsoft Windows function) is called to unload 100 the DLL corresponding to the handle that was removed from the list. The handle is deleted 100. The routine 90 repeats steps 94, 98, and 100 until the list becomes empty, upon which the routine 90 exits 96.

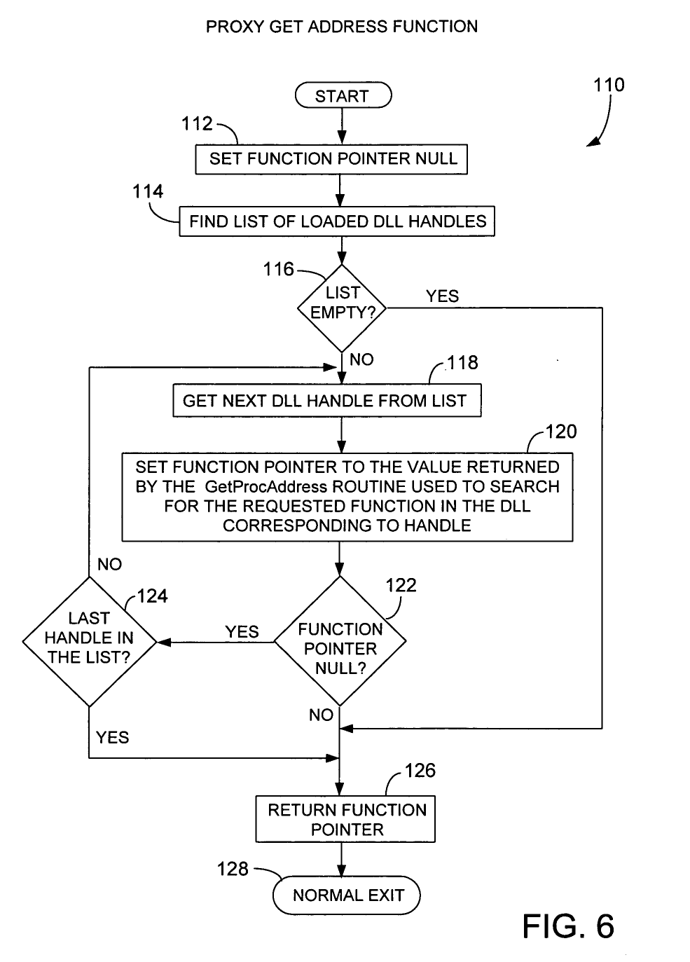

FIG. 6 shows a flow diagram of the proxy get address function 110, which is used for finding the address of an exported function. A function pointer (e.g., Proxy_Function_{—}01) is set 112 to null. A list of loaded DLLs is retrieved 114. The list is examined 116 to determine whether it is empty. If the list is empty, the function pointer is returned 126, and the function 110 exits 128. If the list is not empty, the next DLL handle is retrieved 118 from the list.

A get address function (e.g., GetProcAddress, which is a standard Microsoft Windows function) is called 120 to search the requested function in the DLL corresponding to the DLL handle. Each DLL has a symbol table that lists the address of each exported function. The GetProcAddress function searches the symbol table to find a match between an entry in the table and the function whose address is sought. The function pointer is set 120 to the value returned by the GetProcAddress function. The function pointer is tested 122 to determine whether it is valid.

If the function pointer is valid (not NULL), indicating that the function was found in the DLL, the function 110 returns the function pointer 126 and exits 128.

If the function pointer is null, which means that the function was not found in the DLL, the DLL handle is examined 124 to determine whether it is the last handle in the list. If the DLL handle is the last handle in the list, the function pointer is returned 126, and the function 110 exits 128. If the DLL handle is not the last handle in the list, steps 118, 120, 122, and 124 are repeated until the last DLL handle in the list has been processed.

The difference between the proxy get address function 110 and the get address function (e.g., GetProcAddress) is as follows. The proxy get address function 110 searches a list of DLLs to determine whether a specified function is an exported function of one of the DLLs, calls the get address function to obtain the address of the specified function, and returns the address of the specified function. The get address function searches within the symbol table of a specified DLL to find the address of a specified function of the specified DLL.

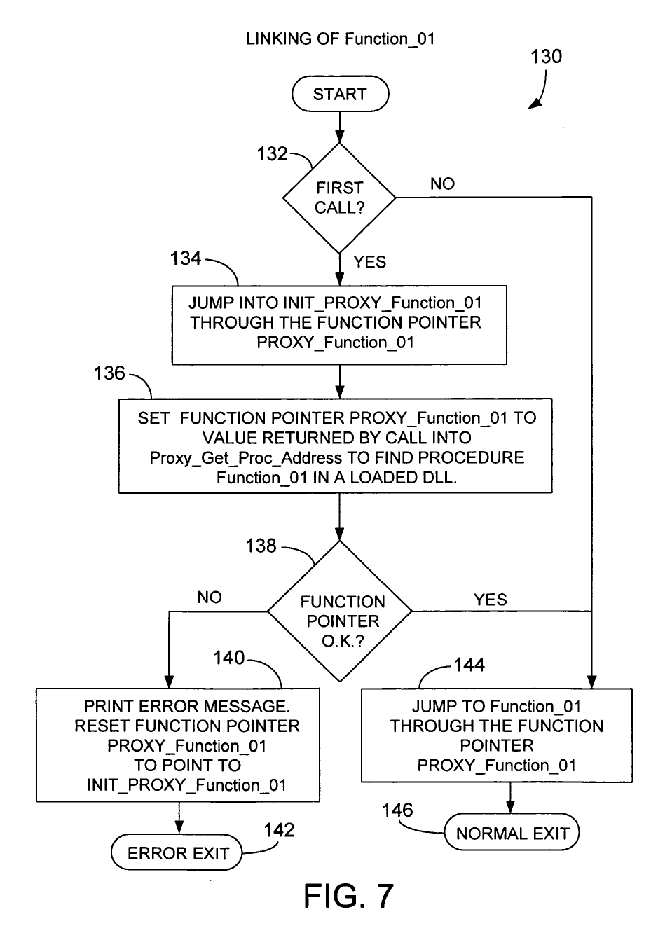

FIG. 7 shows a flow diagram of a process 130 that allows a DLL to call a function that is exported by another DLL after the DLLs have been linked using the process 20. In this example, the exported function to be called is Function_{—}01. The calling DLL determines 132 whether this is the first time that the function is called. If the function has been called before, a function pointer Proxy_Function_{—}01 has already been established to point to the function. In this case, the process 130 jumps 144 to Function_{—}01 through the function pointer Proxy_Function_{—}01, and exits 146.

If this is the first time that Function_{—}01 is called, the calling DLL will not know the address of Function_{—}01. The process 130 jumps 134 to a surrogate function Initial_Proxy_Function_{—}01 through the function pointer Proxy_Function_{—}01. The function pointer Proxy_Function_{—}01 is set to point to the address of the surrogate function when the function pointer is initialized. A Proxy_Get_Proc_Address function (which is similar to the proxy get address function 110 described in FIG. 6) is executed to find 136 the address of Function_{—}01 in one of the loaded DLLs. The function Proxy_Get_Proc_Address returns the address of the Function_{—}01, and the function pointer Proxy_Function_{—}01 is set 136 to the returned address.

The function pointer Proxy_Function_{—}01 is tested 138 to determine whether it is valid. If the function pointer is not valid, an error message is printed 140. The function pointer Proxy_Function_{—}01 is reset to point to the address of the surrogate function, Initial_Proxy_Function_{—}01, and the process 130 exits 142. If the function pointer is valid, the process 130 jumps 144 to Function_{—}01 through the function pointer Proxy_Function_{—}01, which has been assigned the address of the Function_{—}01 in step 136, and exits 146.

The process 130 provides a mechanism in which an exported function can be accessed by a DLL even when the DLL initially does not know the address of the exported function. The first time the exported function is called, the function pointer Proxy_Function_{—}01 is set to point to the address of a surrogate function, which finds the address of the Function_{—}01, and sets the function pointer to point to the address of Function_{—}01. The next time that the exported function is called, the function pointer has already been set to point to the exported function, thus the surrogate function is not invoked, and the exported function is accessed directly.

When there are several functions that are exported by a DLL, a separate segment of code is provided for each of the exported functions to implement a process for calling the exported function, similar to the process 130. For example, for a DLL to call an exported function Function_{—}02, a process similar to process 130 is executed, except that the function pointer Proxy_Function_{—}01 is replaced by Proxy_Function_{—}02, the surrogate function Initial_Proxy_Function_{—}01 is replaced by Initial_Proxy_Function_{—}02, and the argument passed to Proxy_Get_Proc_Address becomes Function_{—}02.

In one example, the processes (e.g., 130) for calling the exported functions can be implemented in the C++ programming language. The code for implementing the processes can be automatically generated using C++ pre-processor macros that decorate function prototypes in a header file. The following describes how macros can be implemented so that, when expanded by the pre-processor, they produce code to implement the processes that allow calling of exported functions.

A standard C++ prototype for a function that is neither imported nor exported by DLLs can have the following format:
int Function_{—}01 (char *command_string),
   where Function_{—}01 is the function name, command_string is the argument list passed to the function, and “int” indicates that the function returns an integer value.

When a function (e.g., Function_{—}01) is to be used in a DLL application (e.g., 24), the prototype shown above can be decorated by a C++ pre-preprocessor macro. The macro prefixes the function name with the return type and compiler directives, which define function characteristics and whether the function is being imported or exported.

For example, to allow an exported function (e.g., Function_{—}01) to be used in a DLL application, a function prototype shown below can be included in a header file that defines functions used in the DLL application:
XACTAPI Function_{—}01(char *command_string).

Here, the string XACTAPI can be defined as a macro similar to the one shown below, which is suitable for applications that do not use DLLs (DLL_USE not defined) and applications that use DLLs (DLL_USE defined with either DLL_IMPORT or DLL_EXPORT defined).

| | |
|---|---|
| #ifdef | DLL_USE |
| #ifdef | WIN32 |
| #if | defined( DLL_IMPORT ) && !defined( DLL_EXPORT ) |
| #define | XACTAPI _declspec(dllimport) int __cdecl |
| #elif | defined( DLL_EXPORT ) && !defined( DLL_IMPORT ) |
| #define | XACTAPI _declspec(dllexport) int __cdecl |
| #else | |
| #error | Neither DLL_IMPORT and DLL_EXPORT are set or both are! |
| #endif | |

#elif_linux_{—}

| | |
|---|---|
| #define | XACTAPI int |
| #endif | |
| #else | |
| #define | XACTAPI int |
| #endif | |

In the above code, the variable DLL_USE indicates whether the application uses DLLs, the variable WIN32 indicates whether this is a Windows environment, the variable DLL_IMPORT indicates whether the function (e.g., Function_{—}01) is an imported function, and the variable DLL_EXPORT indicates whether the function is an exported function.

To generate code for implementing the processes (e.g., 130) for calling the exported functions, macros can be written to further decorate each function prototype declaration as shown below:
XACTAPI_PROXY(XACTAPI, Function_{—}01, (char *command_string)).
   Here the entire function prototype is wrapped in the XACTAPI_PROXY function macro that accepts three arguments. The first macro argument defines the return type of the function named by the second macro argument. The second macro argument contains the function name. The third macro argument defines the formal argument list of the function named in the second macro argument.

Depending on the setting of a pre-processor variable that controls how the function macro is expanded, the XACTAPI_PROXY function macro can (1) generate a function prototype suitable for use in applications that do not use DLLs, (2) generate a function prototype suitable for use in applications that use DLLs, or (3) generate a sequence of code implementing the process 130. To use the XACTAPI_PROXY function macro to generate code that implements the process 130, the preprocessor variable USE_DLL is not defined and the pre-processor variable controlling expansion of XACTAPI_PROXY is defined.

The definition of the XACTAPI_PROXY function macro is written so that, when the C++ preprocessor expands the function macro, the code for implementing the process 130 is automatically generated. The following describes a process 150 that is implemented when the C++ preprocessor expands the XACTAPI_PROXY function macro.

Code for a standard function prototype (one that is neither imported or exported by a DLL) for the named function (e.g., Function_{—}01) is generated 152 based on the macro arguments.

Code for a function prototype for a surrogate function with a unique name (e.g., Initial_Proxy_Function_{—}01) derived from the function named in the second macro argument (e.g., Function_{—}01) is generated 154. The surrogate function has the same return type (e.g., XACTAPI) and formal argument list (e.g., command_string) as the function named by the second macro argument. The surrogate function (e.g., Initial_Proxy_Function_{—}01) is the function that is executed the first time the named function (e.g., Function_{—}01) is called.

Code for a uniquely named function pointer (e.g., Proxy_Function_{—}01) derived from the second macro argument is generated 156. The function pointer points to functions of the type defined in the prototypes generated in steps 152 and 154. The function pointer is initialized in its declaration to the address of the surrogate function (which is named in the prototype generated in step 154) so that when the function (e.g., Function_{—}01) is called for the first time, the process 150 will jump to the surrogate function.

Code for the surrogate function having the name and type declared by the function prototype provided in step 154 is generated 158. The body of the surrogate function contains three statements—an assignment statement, an IF statement with a success clause and an ELSE clause, and a RETURN statement. The generated assignment statement updates the function pointer (e.g., Proxy_Function_{—}01) generated in step 156 with the address returned by the get address function (e.g., Proxy_Get_Proc_Address) described in FIG. 6, which is called with the function named by the second macro argument (e.g., Function_{—}01). The code generated in step 158 implements step 136 in the process 130 (FIG. 7).

The generated IF statement inspects the value of the function pointer assigned in the previous statement for a non-null value. The success clause generated for the IF statement contains assembly code to unwind the stack to the call frame and jump into the function pointed to by the function pointer declared in step 156. The ELSE clause generated for the IF statement contains a statement that attempts to report an error message and a statement that restores the function pointer declared in step 156 to its initial value (which is the address of the surrogate function). The body of the surrogate function includes a RETURN statement.

Code for a function with the name and type declared by the function prototype provided in step 152 is generated 160. The body of the function contains assembly code to unwind the stack to the call frame and then jump into the function pointed to by the function pointer declared in step 156. The body of the function includes a RETURN statement.

A header file is provided with a function macro for each of the functions that are exported by the DLLs 24. For example, if there are three exported functions, Function_{—}01, Function_{—}02, and Function_{—}03, the header file would include the following function prototype declarations:

| XACTAPI_PROXY( XACTAPI, | ( char *command_string |
|---|---|
| Function_01, | 1 ) ); |
| XACTAPI_PROXY( macro 2, Function_02, | ( char *command_string |
| | 2 ) ); |
| XACTAPI_PROXY( macro 3, Function 03, | ( char *command string |
| | 3 ) ); |

where macro 2 and macro 3 are macros that can be further expanded, similar to XACTAPI. For example, the declaration
XACTAPI_PROXY(macro 2, Function_{—}02, (char *command_string 2)),
   when expanded by the preprocessor, generates code to implement a process for calling Function_{—}02, similar to the process 130. The header file can be imported by a DLL (e.g., 24b or 24c) to allow the DLL to use the exported functions, such as Function_{—}01, Function_{—}02, and Function_{—}03.

In one example, the simulator program 16 is an IXP Workbench program from Intel Corporation that provides an interactive user interface to allow a user to simulate and test a family of Intel® IXP network processors. The processor DLL 24a is an XACTOR DLL from Intel Corporation that represents a particular IXP network processor chip, e.g., IXP2400, IXP2600, and IXP2800 network processors. The device DLL 24b is a foreign model DLL that include parameters of board level devices, such as external memory devices, clock devices, and other logic circuits. The simulation DLL 24c is an IXP Workbench DLL that manages resources and sets forth simulation conditions of the IXP Workbench.

The process 150, which is implemented by the code defining the function macros described above, such as XACTAPI_PROXY, provides an efficient means of updating, adding, or removing DLLs that are used by the simulator program 16. For example, if new device DLLs 24b or simulation DLLs 24c are added, their exported functions are added to the list of function macros in the header file. When other DLLs import the header file, the preprocessor automatically generate code that allow the DLLs to call those additional exported functions.

The processes described above provide a means for explicitly accessing sharable functions of loaded DLLs. The address of a sharable function is not fixed upon initiation of the application program, and may depend on conditions at the time when the DLL is actually loaded. When several DLLs are loaded, one DLL initially may not know the addresses of the sharable functions or the parameters that need to be passed to the sharable functions of another DLL. The processes described above allow an application program that does not know the names of DLLs that it needs to load until run-time, to obtain the names of DLLs and their exported functions at run-time, explicitly load the DLLs into memory, explicitly link to each sharable function in each loaded DLL, explicitly link each DLL to the other DLLs, and to unload the loaded DLLs.

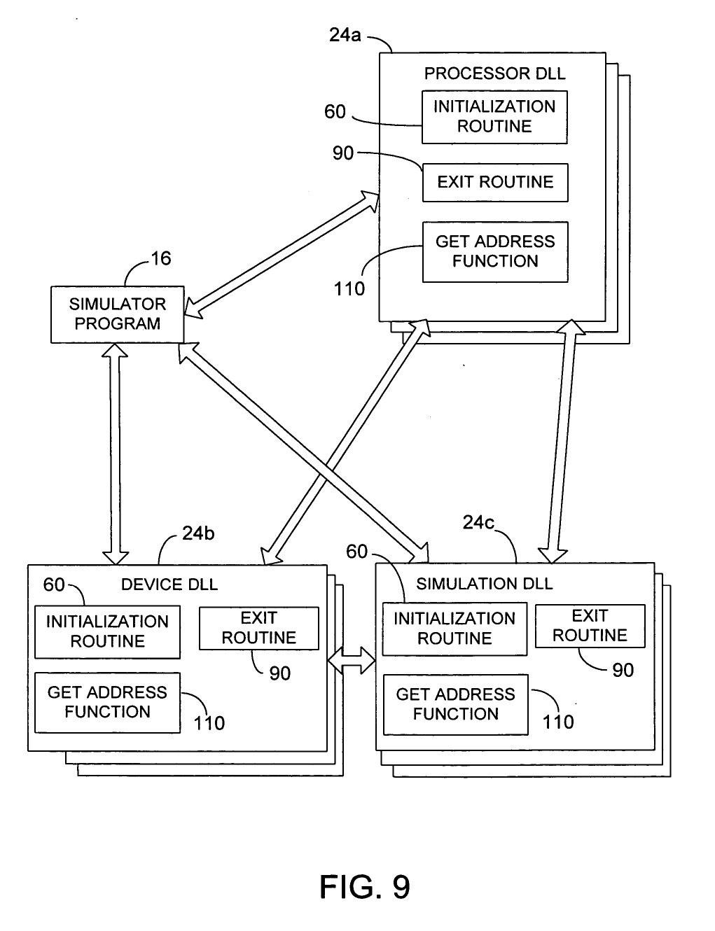

Although some examples have been discussed above, other implementations and applications are also within the scope of the following claims. For example, the simulator program 16 can be used to simulate devices other than processors. The DLLs may export different types of symbols, such as data values. The simulator program 16 may load each of the DLLs, such as the processor DLL 24a, the device DLLs 24b, and the simulation DLLs 24c, and instruct the DLLs to link to one another, as shown in FIG. 9. The processes described above can be configured for different operating systems.

What is claimed is:

1. A method comprising:
explicitly loading a first dynamic link library (DLL);
instructing the first DLL to explicitly load a second DLL to cause exported symbols of the second DLL to be accessible to the first DLL, the second DLL having code to implement an initialization routine to enable the second DLL to load another DLL; and
calling the initialization routine in the second DLL to load the first DLL to cause exported symbols of the first DLL to be accessible to the second DLL.

2. The method of claim 1, further comprising
instructing the first DLL to explicitly load a third DLL to cause exported symbols of the third DLL to be accessible to the first DLL, the third DLL having code to implement the initialization routine; and
calling the initialization routine in the third DLL to load the first DLL to cause exported symbols of the first DLL to be accessible to the third DLL.

3. The method of claim 2, further comprising calling the initialization routine of the second DLL to load the third DLL to cause exported symbols of the third DLL to be accessible to the second DLL.

4. The method of claim 3, further comprising calling the initialization routine of the third DLL to load the second DLL to cause exported symbols of the second DLL to be accessible to the third DLL.

5. The method of claim 4, further comprising:
instructing the first DLL to explicitly load an additional DLL to cause exported symbols of the additional DLL to be accessible to the first DLL; and
instructing each previously loaded DLL to explicitly load the additional DLL to cause the exported symbols of the additional DLL to be accessible to each of the previously loaded DLL.

6. The method of claim 5, wherein the additional DLL has code to implement the initialization routine, the method further comprising, for each previously loaded DLL, calling the initialization routine in the additional DLL to load the previously loaded DLL to cause exported symbols of the previously loaded DLL to be accessible to the additional DLL.

7. A method comprising:
explicitly loading a first dynamic link library (DLL), the first DLL having code to implement an initialization routine for loading another DLL to cause exported symbols of the other DLL to be accessible to the first DLL;
explicitly loading a second DLL, the second DLL having code to implement the initialization routine;
calling the initialization routine in the first DLL to load the second DLL to cause exported symbols of the second DLL to be accessible to the first DLL; and
calling the initialization routine in the second DLL to load the first DLL to cause exported symbols of the first DLL to be accessible to the second DLL.

8. The method of claim 7, wherein the initialization routine in the first DLL calls a load library function to explicitly load the second DLL, and adds a DLL handle referencing the second DLL to a loaded DLL list, the DLL handle being returned by the load library function.

9. The method of claim 8, further comprising establishing an exit handler to remove the second DLL and DLLs loaded by the second DLL.

10. A method comprising:
receiving a list of DLL handles, each handle being associated with a DLL that has been loaded into a memory;
for each of the DLL handles in the list, determining whether a symbol is an exported symbol of the loaded DLL associated with the handle; and
if a symbol is an exported symbol of the loaded DLL, finding an address of the exported symbol.

11. The method of claim 10, further comprising setting a function pointer to point to the address of the exported symbol.

12. The method of claim 11, further comprising using the function pointer to call the exported symbol from a DLL that is different from the DLL that exported the symbol.

13. The method of claim 10, wherein the symbol comprises at least one of a function, a routine, and a variable.

14. The method of claim 10 in which finding an address of the exported symbol comprises searching a table including a list of symbols exported by the loaded DLL.

15. A method comprising:
executing a first function, including jumping to an address pointed to by a function pointer that is initially set point to an address of a second function; and
executing the second function, including finding an address of a third function, setting the function pointer to point to an address of the third function, and jumping to the address of the third function.

16. The method of claim 15, wherein the second function is executed once, and the first function is executed multiple times.

17. The method of claim 16, wherein executing the first function for the first time results in jumping to the address of the second function, and executing the first function for the second time results in jumping to the address of the third function.

18. The method of claim 15, further comprising generating code for the first function and the second function.

19. The method of claim 18, wherein generating code for the first and second functions comprises expanding a function macro to generate the code.

20. The method of claim 19, wherein the function macro receives a function name as an argument, and the code for the first and second functions are generated based on the function name.

21. The method of claim 15 wherein the third function comprises an exported function of a dynamic link library.

22. A system comprising:
a computer to execute a simulation program to simulate a device;
a storage to store a script file and at least two dynamic link libraries (DLLs) including parameters for modeling the device, the script file when executed causes the at least two DLLs to be loaded into a memory and linked to one another,
each of at least a subset of the DLLs including code to implement an initialization routine to allow a first DLL to load a second DLL to cause exported symbols of the second DLL to be accessible to the first DLL.

23. The system of claim 22, wherein the DLLs include parameters for modeling network processors.

24. The system of claim 22, wherein the script file includes code that when executed causes the DLLs to be sequentially loaded into the memory, and when a new DLL is loaded into memory, each previously loaded DLL loads the new DLL so that exported symbols of the new DLL are available to the previously loaded DLLs, and the new DLL loads each previously loaded DLL so that the exported symbols of the previously loaded DLLs are available to the new DLL.

25. A machine-accessible medium, which when accessed results in a machine performing operations comprising:
explicitly loading a first dynamic link library (DLL);
instructing the first DLL to explicitly load a second DLL to cause exported symbols of the second DLL to be accessible to the first DLL, the second DLL having code to implement an initialization routine to load another DLL; and
calling the initialization routine in the second DLL to load the first DLL to cause exported symbols of the first DLL to be accessible to the second DLL.

26. The machine-accessible medium of claim 25, which when accessed further results in the machine performing operations comprising:
instructing the first DLL to explicitly load a third DLL to cause exported symbols of the third DLL to be accessible to the first DLL, the third DLL having code to implement the initialization routine; and
calling the initialization routine in the third DLL to load the first DLL to cause exported symbols of the first DLL to be accessible to the third DLL.

27. The machine-accessible medium of claim 26, which when accessed further results in the machine performing operations comprising calling the initialization routine of the second DLL to load the third DLL to cause exported symbols of the third DLL to be accessible to the second DLL.

28. The machine-accessible medium of claim 27, which when accessed further results in the machine performing operations comprising calling the initialization routine of the third DLL to load the second DLL to cause exported symbols of the second DLL to be accessible to the third DLL.

29. The machine-accessible medium of claim 28, which when accessed further results in the machine performing operations comprising:
instructing the first DLL to explicitly load an additional DLL to cause exported symbols of the additional DLL to be accessible to the first DLL; and
calling the initialization routine of each of the previously loaded DLL to explicitly load the additional DLL to cause the exported symbols of the additional DLL to be accessible to each of the previously loaded DLL.

30. The machine-accessible medium of claim 29, wherein the additional DLL includes the initialization routine, and when the machine-accessible medium is accessed, further results in the machine performing operations comprising, for each previously loaded DLL, calling the initialization routine of the additional DLL to load the previously loaded DLL to cause exported symbols of the previously loaded DLL to be accessible to the additional DLL.
